(19) United States
(12) Patent Application Publication
(10) Pub. No.: US 2009/0246743 A1
(43) Pub. Date: Oct. 1, 2009

(54) LANGUAGE LEARNING SYSTEM AND METHOD THEREOF

(76) Inventor: Yu-Chun Hsia, Taiwan (CN)

Correspondence Address: SINORICA, LLC, 2275 Research Blvd., Suite 500, ROCKVILLE, MD, 20850, US

(21) Appl. No.: 12/306,726

(22) PCT Filed: Jun. 22, 2007
(86) PCT No.: PCT/CN2007/001961

§ 371 Date: Jun. 13, 2009

(30) Foreign Application Priority Data
Jun. 29, 2006 (CN) 200610090164.3

(51) Int. Cl. G09B 19/06; G09B 5/06

(52) U.S. Cl. 434/157; 434/308

(57) ABSTRACT

A language learning system and a method thereof are disclosed. The language learning system comprises at least one teaching material database and a computer apparatus. The teaching material database comprises original video data, original broadcast sequence data and authored learning data. The computer apparatus comprises a language learning module, a text record table and a broadcast rule table. The language learning module has an index module, a broadcast module and a recording module. The index module compares the original broadcast sequence data with the text record table to generate a broadcast sequence table. At least one learning unit is generated from the original video data or the authored learning data based on the broadcast sequence table. The broadcast module broadcasts the learning unit based on the broadcast rule table. In addition, the computer apparatus can automatically download the broadcast rule table, the learning unit and the language learning module to a portable video broadcast apparatus.

### BACKGROUND OF THE INVENTION

(a) Field of the Invention

The present invention relates to a language learning system and a method thereof, and more particularly to a language learning system that integrates original video data, authored learning data, a computer apparatus and a portable video broadcast apparatus and a method thereof.

(b) Description of the Prior Art

Today, globalized communication is very popular all over the world and people travel between nations frequently. For the convenience of lingual communication, learning foreign languages is becoming a more and more important subject. However, it is necessary to get in touch with and use a language to a great extent frequently and over a long period of time under various situations in a good language learning environment. Since foreign language environment are generally not totally ideal during learning a foreign language, in order to master a foreign language more effectively, the manner that vivid and interesting films are used in situational learning and the practice is conducted frequently on the go has become one of the most important learning modes. In general, learning a foreign language by seeing movies is often employed in situational learning, but the common method is only reading the printed translated book in comparison with the movie. The improved prior arts have utilized computer assisted instruction and video multimedia technologies in recent years, which have the functions of learning by seeing movies, setting repeated broadcast, word learning or repeated broadcast of sentences or the like, but there is no improvement in excessively complicated actions and a lot of keying operation during learning.

In the learning modes that enable making full use of time to chase learning opportunities and get in touch with a foreign language frequently on the go, a word card or a handbook is conventionally often used as a portable foreign language learning tool to be carried with the user for reading. An improved method is using a cassette walkman or a compact disc walkman to practice repeatedly. With lower prices for memory chips, portable video players (such as MP3 and PMP) made of memory chips with large storage capacity have become the lightest and most portable carry-on learning tools. However, the language learning function included in a conventional portable video player is only a simple function of repeatedly broadcasting a selected section (A-B section) or repeatedly broadcasting the contents of one section, or repeatedly broadcasting the contents of each sentence, etc. Such kind of operating functions are only limited to the operation of repeated broadcast, but cannot master the actions which the user must take again and again during language learning. Therefore, there is still a lot of improvement space in the user-friendliness and practicability of existing conventional language learning methods.

We appreciated that each word, phrase, clause or sentence must be repeatedly previewed, practiced and reviewed, and repeatedly practiced for certain times as well as kept under regular review for a long time, and also the tests, transcription and debugging must be continuously repeated in learning a language. In the learning duration, a learner must rely on his own willpower to inspire the willingness to learn in any time and take an instant learning action on the go. Such a complicated learning procedure and a long-lasting learning process are the heavy burdens requiring much attention and concern besides language learning. These would become the greatest handicap to the learning results.

In order to resolve all the problems of the prior art, the inventors propose a language learning system and a method thereof based on their research and development for many years and plenty of practical experience, thereby improving the above shortcomings.

### SUMMARY OF THE INVENTION

In view of the above-mentioned circumstances, an objective of the present invention is to provide a language learning system and a method thereof, thereby increasing the language learning efficiency and decreasing the number of repeat times of operation by a learner.

According to the objective of the present invention, a language learning system is provided, which comprises at least one teaching material database and a computer apparatus. The teaching material database comprises original video data, original broadcast sequence data and authored learning data. The computer apparatus comprises a language learning module, a text record table and a broadcast rule table. The language learning module has an index module, a broadcast module and a recording module. The index module compares the original broadcast sequence data with the text record table to generate a broadcast sequence table. At least one learning unit is generated from the original video data or the authored learning data based on the broadcast sequence table. The broadcast module broadcasts the learning unit based on the broadcast rule table.

Furthermore, the present invention provides a language learning method for assisting a user in language learning using a computer apparatus that comprises a user interface and a broadcast module, the method comprising the following steps: selecting a plurality of learning units from a teaching material database; using a user interface to set a broadcast rule table that comprises a number of repeat times of broadcast and a broadcast interval of each of the learning units; and using a broadcast module to automatically broadcast each of the learning units based on the broadcast rule table.

Moreover, the present invention provides a language learning system for assisting a user in language learning, the system comprising at least one teaching material database, a portable video broadcast apparatus and a computer apparatus. The computer apparatus comprises a language learning module and a broadcast rule table, wherein the language learning module has an index module, a broadcast module and a recording module, and the language learning module generates at least one learning unit from the teaching material database based on the text record table and the broadcast rule table, and the broadcast module broadcasts the learning unit based on the broadcast sequence table and the broadcast rule table. When the broadcast module is broadcasting, the computer apparatus can download the language learning module, the broadcast sequence table, the broadcast rule table and the learning unit corresponding to the broadcast rule table to the portable video broadcast apparatus via a data transmission interface.

As described above, a language learning system and a method thereof according to the present invention have the following advantages:

(1) The complicated language learning procedures can be managed by programs and each learning procedure is automatically executed according to the present invention, so as to decrease the operation frequency during learning.

(2) Situational learning with video multimedia can be executed on a computer according to the present invention, so as to increase the language learning efficiency.

(3) A portable video player, such as an MP3 or a PMP can be adapted to the present invention, which has light and portable characteristics and carries out a language learning method with timed automatic broadcast function and full automatic broadcast of teaching procedures. Thus, the user can learn on the go as well as persistently and naturally get in touch with and repeatedly listen to a foreign language without the initiative of the user to operate. Even though the user spends no time in the arrangement, no learning procedures or words would be missed. The present invention embodies a nearly ideal foreign language learning environment.

The technical features and effects of the present invention may be further understood and appreciated from the following detailed description of the preferred embodiments.

### BRIEF DESCRIPTION OF THE DRAWINGS

The language learning system and its method of preferred embodiments according to the present invention are described below with reference to the related drawings where the same elements are designated with the same reference numerals for the convenience of understanding.

FIG. 1 is a schematic view of a language learning system according to the present invention;

FIG. 2 is a schematic view of a broadcast rule table according to the present invention;

FIG. 3 is a flow chart of a language learning method according to the present invention;

FIG. 4 is a flow chart of a preferred embodiment of a language learning method according to the present invention; and

FIG. 5 is a schematic view of another embodiment of a language learning system according to the present invention.

### DETAILED DESCRIPTION OF THE PREFERRED EMBODIMENTS

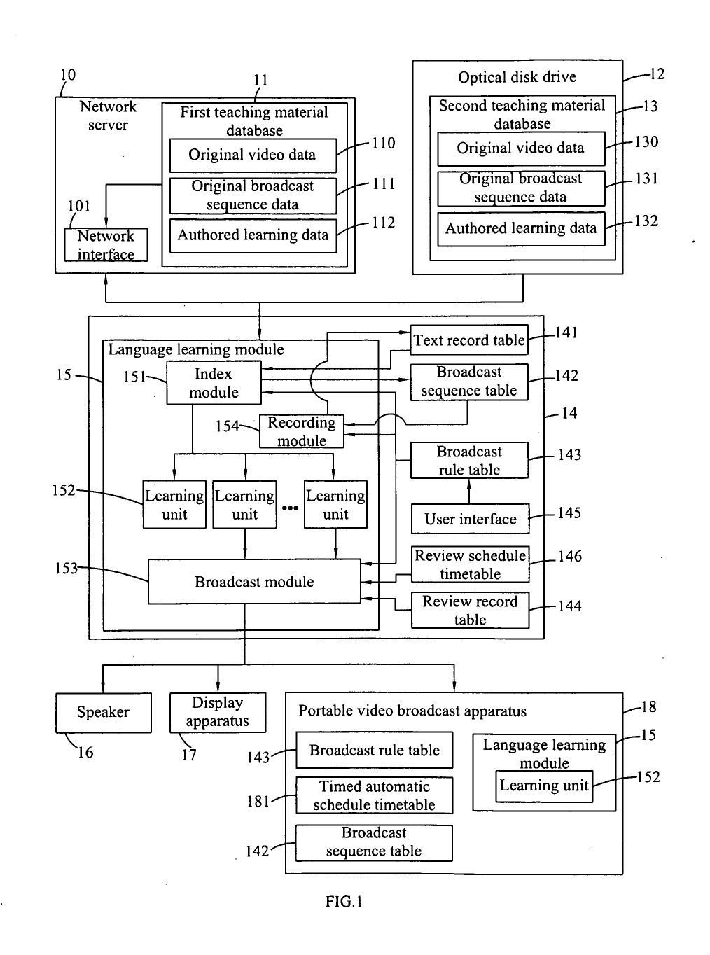

Referring to FIG. 1, there is shown a schematic view of a language learning system according to the present invention. In this figure, the language learning system comprises a first teaching material database 11 stored in a network server 10, a second teaching material database 13 stored in an optical disk drive 12, and a computer apparatus 14. The first teaching material database 11 comprises original video data 110, original broadcast sequence data 111 and authored learning data 112. The second teaching material database 13 comprises original video data 130, original broadcast sequence data 131 and authored learning data 132. The computer apparatus 14 comprises a language learning module 15, a text record table 141 and a broadcast rule table 143. The language learning module 15 has an index module 151, a broadcast module 153 and a recording module 154. The index module 151 compares the original broadcast sequence data 111, 131 with the text record table 141 to generate a broadcast sequence table 142. At least one learning unit 152 is generated from the original video data 110, the original video data 130, the authored learning data 112 or the authored learning data 132 based on the broadcast sequence table 142 and the broadcast rule table 143. The broadcast module 153 broadcasts the learning unit 152 based on the broadcast rule table 143 and the broadcast sequence table 142, and provides the outputs through a speaker 16 or a display apparatus 17.

The original video data 130 is preferably a movie, a television program, a broadcast program, a personal recorded film or audio data. The network server 10 has a network interface 101, and the computer apparatus 14 can read the first teaching material database 11 via the network interface 101. The optical disk drive can be a CDROM or a DVDROM, and the second teaching material database 13 is stored in a CD disc or a DVD disc. The user can use the data of the first teaching material database 11, the data of the second teaching material database 13, or both depending on the language learning requirements.

The original broadcast sequence data 111 and 131 comprises synchronous address index data of the separated data existing in the dialogue contents of the original video data 110 and 130 respectively, wherein the separated data is a word, a phrase, a clause, or a sentence. The synchronous address index data comprises a name, a numerical sequence code, a text file, a separated code, a video time code, a number of broadcast seconds of a file, or a file address of the separated data. During generating the broadcast sequence table 142, the name of the separated data is used for identification, and the text file is used to compare with the text record table 141 for searching, and the separated code is used to correspond to the broadcast rule table 143, and the video time code is used to correspond to the films of the learning unit 152, and the numerical sequence code serves as the basis of broadcast orders of the original broadcast sequence data 111 and 131, and the number of broadcast seconds of a file is used to calculate interval time.

The authored learning data 112 and 132 comprises an audio file of slow pronunciation of a foreign language, an audio file of standard pronunciation of a foreign language, an audio file of pronunciation of a translation, a voice audio file of a detailed exposition of a translation, a text file of a foreign language, a text file of phonetic symbols of a foreign language, a text file of a translation, an image file of a film, an audio file of a film, or a graphic file of a degree of lip-rounding.

The index module 151 is used to compare the original broadcast sequence data 111 with the text record table 141 one by one. If the text of the original broadcast sequence data 111 does not appear in the text record table 141, the original broadcast sequence data to which the text belongs is stored in the broadcast sequence table 142. The text record table 141 comprises the text contents which the user has learnt, whose record format comprises a word field, a phrase field, a clause field, and a sentence field. The language learning module 15 further comprises a recording module 154 for compiling the text record table 141 such that the recording module 154 can automatically generate the text record table 141 in the duration that the user is learning based on broadcasted contents in the broadcast rule table 143 and the broadcast sequence table 142. Alternatively, the user manually compiles the text record table 141. The user selects the already learnt words by oneself, thus capable of increasing the learning efficiency of the user by excluding the already learnt words.

The learning unit 152 is the data of the separated data (such as words, phrases, clauses or sentences) which the user wants to learn, and can comprise phonetic symbol data, text data of a foreign language, translation text of a foreign language, slow pronunciation data of a foreign language, standard pronunciation data of a foreign language, soundtrack data of a foreign language film, pronunciation data of a translation, data of a detailed exposition of a translation, or a part of original video data.

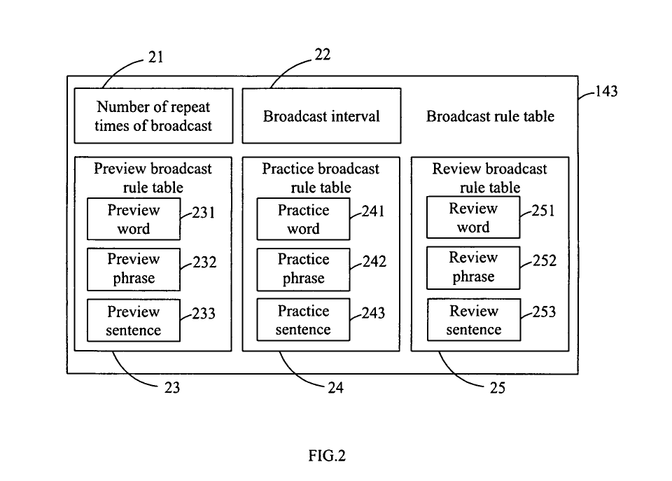

The broadcast rule table 143 comprises a plurality of broadcast rules suitable for multiple different learning stages and situations like previewing, practicing, reviewing, learning words, learning phrases, learning clauses or learning sentences. As illustrated in FIG. 2, the broadcast rule table 143 at least comprises a number 21 of repeat times of broadcast and a broadcast interval 22 of each learning unit 152. In addition, the broadcast rule table 143 also optionally comprises a preview broadcast rule table 23, a practice broadcast rule table 24, and a review broadcast rule table 25. The preview broadcast rule table 23 comprises a preview word 231, a preview phrase 232 and a preview sentence 233. The practice broadcast rule table 24 comprises a practice word 241, a practice phrase 242 and a practice sentence 243. The review broadcast rule table 25 comprises a review word 251, a review phrase 252 and a review sentence 253. The computer apparatus further comprises a user interface 145 to allow the user to set the broadcast rule table 143 and the data to be learned from each learning unit 152. The broadcast module 153 broadcasts the learning unit 152 based on the broadcast rule table 143 to allow the user to preview, practice or review words, phrases or sentences. The operation steps of a learning process can be reduced by setting the number 21 of repeat times of broadcast and the broadcast interval 22.

Furthermore, the computer apparatus optionally comprises a review record table 144 and a review schedule timetable 146. When the language learning module 15 is executed, the user is notified of whether to enter a review mode or not. If yes, the language learning module 15 carries out a review procedure based on the review record table 144 and practices the contents of the review record table 144 based on the review broadcast rule table 25. The review record table 144 records the portion which the user has been practiced. The review schedule timetable 146 relates to date intervals between multiple repeated reviews which the user sets by oneself and several time points on review dates which the user sets to have reviews by oneself. In addition, when the language learning module 15 is executed, the review dates in the review schedule timetable 146 are compared. When a review date arrives, the contents of the review record table 144 are executed based on the predetermined time. Thus, a user-specified periodic and timed review procedure can be formed to achieve the effects of automatic review.

The language learning system optionally comprises a portable video broadcast apparatus 18. When the broadcast module 153 is broadcasting, the computer apparatus 14 can download the language learning module 15, the broadcast sequence table 142, the broadcast rule table 143 and the learning unit 152 corresponding to the broadcast rule table 143 to the portable video broadcast apparatus 18 via a data transmission interface. The portable video broadcast apparatus 18 can comprise a timed automatic schedule timetable 181 to periodically and timely carry out the user's language learning. The timed automatic schedule timetable 181 is preferably in terms of a week, and every day in a week can be set with a schedule timetable of which the contents are automatically broadcast over multiple time periods.

The computer apparatus 14 is preferably a desktop computer or a notebook computer. The language learning module 15 is implemented preferably in a manner that the microprocessor of the computer apparatus executes a language learning program. The portable video broadcast apparatus 18 is preferably an MP3 player or a portable multimedia player (PMP). The data transmission interface is preferably a universal serial bus (USB) interface.

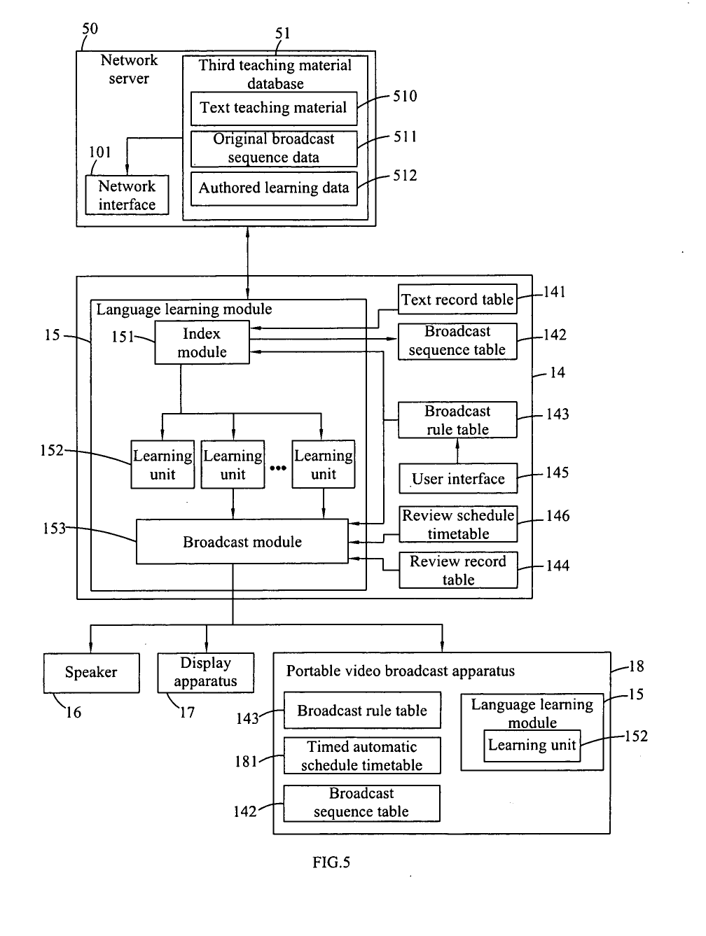

Moreover, the language learning system can be applied to the language learning of text teaching material. Referring to FIG. 5, the language learning system can comprise text teaching material 510, original broadcast sequence data 511 corresponding to the text teaching material 510, authored learning data 512 corresponding to the text teaching material 510 and a computer apparatus 14. The computer apparatus 14 comprises a language learning module 15, a text record table 141 and a broadcast rule table 143. The language learning module 15 has an index module 151 and a broadcast module 153. The index module 151 compares the original broadcast sequence data 511 with the text record table 141 to generate a broadcast sequence table 142. At least one learning unit 152 is generated from text teaching material 510, the authored learning data 512 based on the broadcast sequence table 142 and the broadcast rule table 143. The broadcast module 153 broadcasts the learning unit 152 based on the broadcast rule table 143, and provides the outputs through a speaker 16 or a display apparatus 17.

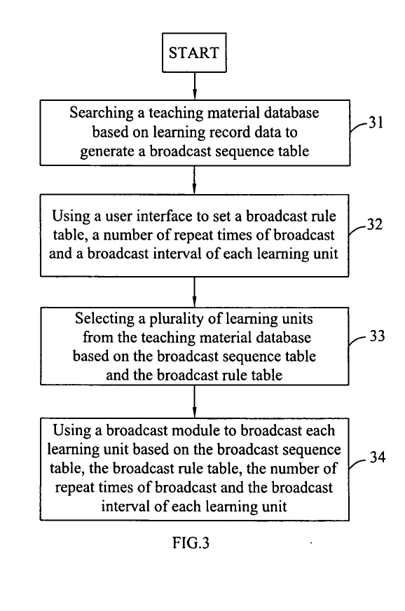

Referring to FIG. 3, there is shown a flow chart of a language learning method according to the present invention. In this figure, the method is used for assisting a user in language learning using a computer apparatus that comprises a user interface and a broadcast module, the method comprising the following steps:

Step 31: searching the original broadcast sequence data of a teaching material database based on learning record data to generate a broadcast sequence table;

Step 32: using a user interface to set a broadcast rule table, a number of repeat times of broadcast and a broadcast interval of each learning unit;

Step 33: selecting a plurality of learning units from the teaching material database based on the broadcast sequence table and the broadcast rule table;

Step 34: using a broadcast module to repeatedly broadcast each learning unit based on the broadcast sequence table, the broadcast rule table, the number of repeat times of broadcast and the broadcast interval of each learning unit.

In these steps, the learning record data comprises the text records which the user has learnt. The above teaching material database is stored in a network server, an optical disk drive, or combinations thereof. The teaching material database comprises original video data, original broadcast sequence data and authored learning data. The above learning unit comprises phonetic symbol data, text data of a foreign language, translation text of a foreign language, slow pronunciation data of a foreign language, standard pronunciation data of a foreign language, soundtrack data of a foreign language film, pronunciation data of a translation, data of a detailed exposition of a translation, or a part of original video data.

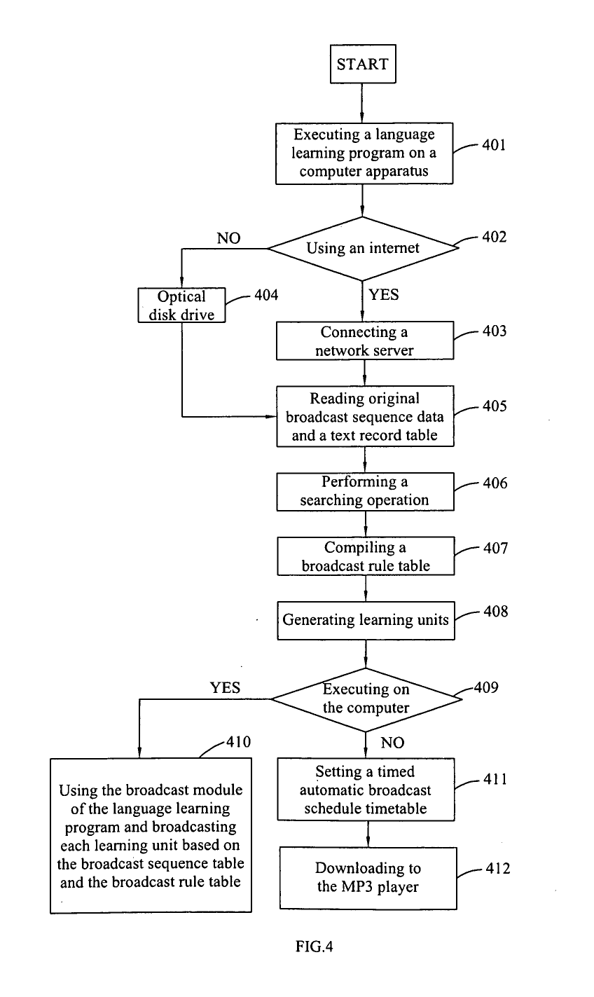

Referring to FIG. 4, there is shown a flow chart of a preferred embodiment of a language learning method according to the present invention, the method comprising the following steps:

Step 401: executing a language learning program on a computer apparatus;

Step 402: deciding whether a teaching material database is downloaded from an internet or not;

Step 403: if yes, reading the data of a teaching material database through the connection of a server of an internet with a global information website;

Step 404: if no, reading the data of a teaching material database via an optical disk drive of the computer apparatus;

Step 405: reading original broadcast sequence data and a text record table of the computer apparatus from the data of the teaching material database;

Step 406: using the index module of the language learning program to compare the original broadcast sequence data with a text record table, finding the words, phrases, clauses or sentences that do not appear in the text record table and recording them in a broadcast sequence table;

Step 407: using a user interface of the language learning program to set a number of repeat times of broadcast and a broadcast interval of each learning unit to compile a broadcast rule table;

Step 408: generating a plurality of learning units from the data of the teaching material database based on the broadcast sequence table and the broadcast rule table;

Step 409: deciding whether language learning is executed on the computer or executed on a digital MP3 player after download;

Step 410: if it is decided that language learning is executed on the computer, using the broadcast module of the language learning program and broadcasting each learning unit based on the broadcast sequence table and the broadcast rule table;

Step 411: if it is decided that language learning is executed on an MP3 player after download, setting a timed automatic broadcast schedule timetable of the MP3 player;
Step 412: downloading the language learning program, the broadcast sequence table, the broadcast rule table and the learning unit corresponding to the broadcast rule table to the MP3 player through a USB line.

What is claimed is:

1-59. (canceled)

60. A language learning system for assisting a user in language learning, the system comprising:
at least one teaching material database that comprises original video data, original broadcast sequence data and authored learning data; and
a computer apparatus that comprises a language learning module, a text record table and a broadcast rule table, wherein the language learning module has an index module and a broadcast module, and the index module compares the original broadcast sequence data with the text record table to generate a broadcast sequence table, and at least one learning unit is generated from the original video data or the authored learning data based on the broadcast sequence table and the broadcast rule table, and the broadcast module broadcasts the learning unit based on the broadcast rule table.

61. The language learning system as claimed in claim 60, wherein the teaching material database is stored in a network server, an optical disk drive, or combinations thereof.

62. The language learning system as claimed in claim 60, wherein the original broadcast sequence data comprises synchronous address index data of the separated data of text corresponding to the dialogue contents of the film programs or audio programs in the original video data, wherein the separated data is a word, a phrase, a clause, or a sentence.

63. The language learning system as claimed in claim 62, wherein the synchronous address index data comprises a name, a numerical sequence code, a text file, a separated code, a video time code, a number of broadcast seconds of a video file, or a file address of the separated data.

64. The language learning system as claimed in claim 60, wherein the index module compares the original broadcast sequence data with the text record table one by one, and if the text in one serial number text field of the original broadcast sequence data does not appear in the text record table, the original broadcast sequence data to which the text belongs is stored in the broadcast sequence table and defined as a learning unit that must be repeatedly practiced.

65. The language learning system as claimed in claim 60, further comprising a portable video broadcast apparatus to which the language learning module, the broadcast sequence table, the broadcast rule table and the learning unit corresponding to the broadcast rule table are downloaded from the computer apparatus.

66. The language learning system as claimed in claim 60, wherein the text record table comprises the text contents which the user has learnt and the record format of the text record table comprises a word field, a phrase field, a clause field, and a sentence field.

67. The language learning system as claimed in claim 66, wherein the language learning module further comprises a recording module for automatically compiling the text record table based on broadcasted contents in the broadcast rule table and the broadcast sequence table.

68. The language learning system as claimed in claim 66, wherein the text record table is manually set by the user.

69. The language learning system as claimed in claim 60, wherein the computer apparatus further comprises a review schedule timetable and a review record table, and when the language learning module is executed, the user is notified of whether to enter a review mode or not, and if yes, the language learning module carries out a review procedure based on the contents of the review schedule timetable and the review record table.

70. A language learning method for assisting a user in language learning using a computer apparatus that comprises a user interface and a broadcast module, the method comprising the following steps:
searching the original broadcast sequence data of video teaching material of a teaching material database based on learning record data to generate a broadcast sequence table;
using a user interface to set a broadcast rule table, a number of repeat times of broadcast and a broadcast interval of each of the learning units;
selecting a plurality of learning units from the teaching material database based on the broadcast sequence table and the broadcast rule table; and
using a broadcast module to broadcast each of the learning units based on the broadcast sequence table, the broadcast rule table, the number of repeat times of broadcast and the broadcast interval of each of the learning units.

71. The language learning method as claimed in claim 70, wherein the learning record data comprises the text records which the user has learnt.

72. The language learning method as claimed in claim 70, wherein the teaching material database is stored in a network server, an optical disk drive, or combinations thereof.

73. The language learning method as claimed in claim 70, wherein the teaching material database comprises original video data, original broadcast sequence data and authored learning data.

74. The language learning method as claimed in claim 70, wherein the step of selecting a plurality of learning units from a teaching material database is performed by using an index module to compare the original broadcast sequence data with a text record table to generate a broadcast sequence table, and generating the learning units from the original video data or the authored learning data based on the broadcast sequence table.

75. The language learning method as claimed in claim 70, further comprising downloading the language learning module, the broadcast sequence table, the broadcast rule table and the learning unit corresponding to the broadcast rule table to a portable video broadcast apparatus when the broadcast module of the computer apparatus is broadcasting.

76. A language learning system for assisting a user in language learning, the system comprising:
at least one teaching material database;
a portable video broadcast apparatus; and
a computer apparatus that comprises a language learning module and a broadcast rule table, wherein the language learning module has an index module and a broadcast module, and the language learning module generates at least one learning unit from the teaching material database based on the broadcast rule table, and the broadcast module broadcasts the learning unit based on the broadcast rule table;
wherein the computer apparatus downloads the language learning module, the broadcast rule table and the learning unit corresponding to the broadcast rule table to the portable video broadcast apparatus via a data transmission interface, and the broadcast rule table at least comprises a number of repeat times of broadcast and a broadcast interval of each of the learning units.

77. The language learning system as claimed in claim 76, wherein the teaching material database is stored in a network server or an optical disk drive.

78. The language learning system as claimed in claim 76, wherein the teaching material database comprises original video data, original broadcast sequence data and authored learning data.

79. The language learning system as claimed in claim 76, wherein the original broadcast sequence data comprises synchronous address index data of the separated data of text corresponding to the dialogue contents of the film programs or audio programs in the original video data, wherein the separated data is a word, a phrase, a clause, or a sentence.

80. The language learning system as claimed in claim 76, wherein the synchronous address index data comprises a name, a numerical sequence code, a text file, a separated code, a video time code, a number of broadcast seconds of a file, or a file address of the separated data.
